(19) United States
(12) Patent Application Publication
(10) Pub. No.: US 2014/0067632 A1
(43) Pub. Date: Mar. 6, 2014

(54) Automatic Generation of Transfer Pricing Documentation

(71) Applicant: Stephen Curtis, Weston, CT (US)

(72) Inventor: Stephen Curtis, Weston, CT (US)

(73) Assignee: ERNST & YOUNG LLP, New York, NY (US)

(21) Appl. No.: 13/604,830

(22) Filed: Sep. 6, 2012

(51) Int. Cl. G06Q 40/00

(52) U.S. Cl. 705/31; 705/30

(57) ABSTRACT

A system and method for automatically generating transfer price documentation is described. In some examples, the system includes a tool that receives information from an enterprise for provided services and intangibles within the enterprise, automatically determines one or more allocations for the provided services and intangibles, and generates reports based on the determined allocations.

### BACKGROUND

Transfer pricing refers to setting, analyzing, documenting, and/or adjusting charges made between related entities in an enterprise for goods, services, and/or use of property, including intangible property. Often reflecting an allocation of resources between the entities, transfer prices determine the taxable profits between associated entities within the enterprise, including profits across different taxed jurisdictions.

Most governments rely on transfer pricing rules when determining and/or adjusting income taxes for both domestic and multi-national enterprises. For example, enterprises operating within the United States follow US Treasury Regulations Section 1.482-9, which provides for “methods to determine taxable income in connection with a controlled services transaction,” as well as “Transfer Pricing Guidelines for Multinational Enterprises” promulgated by the Organization for Economic Cooperation and Development (OECD).

Although an enterprise is unrestrained with respect to setting prices between related entities, the United States Treasury may adjust the prices when they are considered to be outside an “arm's length range.” In general, the actual prices charged between the related entities are compared with prices charged between unrelated entities during comparable pricing conditions, such as market levels, levels of risk, and so on.

Large, global, multinational companies have complex accounting and expense management systems. These systems are often disparate due to acquisitions, local information technology autonomy, compliance to local accounting standards, and so on.

When one entity of such a company performs services for multiple other entities of the company on a global basis, the entity is generally required to charge for these services as if the parties were unrelated. The cost of the service should be similarly determined. At times, establishing pricing between related parties for services that are not provided for between unrelated parties is highly subjective, which can create problems when determining the charges from an entity providing a service that are passed on to a recipient or beneficiary entity of the service, especially when there are many recipient entities. For example, tax authorities in the jurisdiction of the service providing entity will ensure that all recipient entities are charged for the provided services for which they benefit, and tax authorities in the jurisdictions of the recipient entities will ensure that their local recipient entities are not overcharged for the provided services in relation to the amount of benefit they receive. For an enterprise associated with all of the entities, these tax regulations may be very burdensome, as a charge may increase the tax burden of the service providing entity, without any increase in its net taxable income, if a charge is made by one entity without a corresponding deduction at one or more receiving entities, which may lead to taxation in each separate country on the same income (i.e. double taxation). Thus, accurately calculating the charges from a headquarters entity for a global, multi-national company, or other enterprise, becomes an important and difficult, endeavor with substantial implications for the profitability of the company, among other problems.

A typical and generally accepted method for allocating charges from an entity, such as a global headquarters, is to divide up the fully loaded costs of the entity by department and add a markup to the services cost, with the sum representing the arm's length charge for the services. The services cost plus the markup may then be allocated to the receiving entities on an equitable basis, such as by a percentage of sales, headcount, production volume, and/or some other logical business driver. While this may work for internal computations, this is generally not acceptable under prevailing international transfer pricing rules, which also require supporting documentation of the functions performed, the benefits received, and that the ultimate charge is one that reflects an arm's length result for both parties.

Often, there are multiple services and service categories that are provided by a large headquarters operation, which may benefit different types of entities in many different ways. For example, business development services in a United States entity may have a different benefit for a full-fledged selling operation in a country, and it may conversely have zero benefit for a contract R&D operation in another country.

Therefore, determining the cost of such a service, the amount of that cost that is beneficial and allocable, the amount of markup to add, identifying the beneficiaries and their relative share of the benefit, and therefore the cost, has been a challenging task for controllers, tax and transfer pricing practitioners within large multi-national organizations. Often they will enlist the help of accounting firms, law firms, economics consulting firms, and other services providers to assist with these calculations and to verify that the charges will be in compliance with the arm's length principle.

Typically, the calculations are highly manual, labor intensive and subjective, involving timesheets, spreadsheets, financial system and other database outputs, qualitative and functional information, involving estimates and/or guesswork, and the exercise may be subject to inconsistencies and other errors. For example, in order to determine a calculation, transfer pricing teams may visit a company and perform the following tasks to determine proper arm's length charges for inter-company services: (a) interview service providers to define and document the provided services according to the transfer pricing rules for both the recipient and provider country, (b) interview service recipients to verify the benefit of the provided services in the recipient country, (c) calculate the total cost base of the services, (d) calculate the total allocable cost base of the services, (e) determine an appropriate markup for each provided service in question, and/or (f) allocate a cost and profit element to each service recipient based on the amount of benefit to the recipient.

At the end of the process, the company provides contemporaneous documentation about the method for calculating transfer prices, which is a requirement of the United States transfer pricing legislation. This could be a highly iterative process as service recipients may be unmotivated to receive these charges, and may negotiate to have the charges reduced. They may debate the total charge and/or challenge the determined benefit of the service for their entity, which may push costs back into the overall cost pool and in some cases may increase the charge to other service recipients. Alternatively, tax authorities in the recipient country may challenge the services charges if sufficient documentation is not prepared, due to the erosion of the local income tax base, as the services charges reduce the profit of the recipient entity.

Typically, these charges are captured on numerous spreadsheets or other similar tools, with the ability to create what-if analyses or other iterative analyses or calculations being limited by the technology used in the process, such as the process of determining transfer pricing between entities.

While aforementioned systems are generally suitable for a particular purpose, such systems are not sufficiently suitable for the purpose discussed in the present invention, because they do not contain the ability to compute the charges under all transfer pricing methods and at all points in the range as required by international transfer pricing regulations within a single exercise, or to provide the required reconciliations regardless of method applied. Thus, it is clear that there exists a need in the art for a system that overcomes these problems and progresses the state of the art, as well as one that provides the additional benefits enumerated in the present application.

### SUMMARY OF THE INVENTION

In view of the foregoing disadvantages inherent in the art, in accordance with a first preferred embodiment of the present invention, a system and method for automatically generating transfer-pricing documentation is described. The system determines transfer prices for provided services by computing multiple allocations, in some cases using matrix multiplication techniques. The system outputs the determined transfer prices and associated documentation for both service providers and recipients within an enterprise. The outputted information may be used as components of principal documents, required under Section 1.6662 of the United States Internal Revenue Code, that demonstrate contemporaneous compliance with transfer pricing regulations.

In some examples, the system performs one or more cost allocations for services between service providers and service recipients, and determines transfer prices based on the performed cost allocations. That is, in some cases, the system may perform a variety of different allocations during a transfer pricing analysis, among other things.

In accordance with alternative embodiments, the system determines transfer prices by utilizing various different cost allocation techniques. That is, the system may perform one type of cost allocation for a legal entity, and perform a different type of cost allocation for a different legal entity.

Therefore, in some examples, the system enables organizations, such as companies and enterprises, to automatically determine and generate transfer-pricing documentation for services provided between entities within the organizations. The automatic generation may provide an organization with flexibility benefits, because the system is capable of accomplishing many types of allocations with a high level of detail and flexibility, resulting in simplicity benefits, because the system automates the allocation process, reducing the complexity, time, and labor associated with the most complex type of transfer pricing analysis, optionally consolidating multiple services analyses into single processes, and transparency benefits, because the system can be used to support or increase tax efficiency with reduced examination risk by enabling greater transparency and computational detail, among other benefits. Additional benefits include the ability to import all information into the system, including department and sub-department costs, mark-ups at required points in the range of comparables, allocation methodologies by function, identification of non-allocable costs, tax rates by treaty and country, allocation drivers by recipient, billing details, contract information, and to produce a range of prices simultaneously, as recommended by the United States and OECD transfer pricing guidance, including the interquartile and full range of transfer prices, and computation of the median and average transfer prices by provider and recipient. Yet another benefit is the tax impact measurement of the resulting computations, which can compute the withholding tax and local country income tax liabilities with respect to the charges, based on either the statutory tax rates or the effective tax rates for the respective provider and recipient entities, with a computation of the gross tax impact by country or recipient, and a net worldwide tax impact. Yet another benefit is the ability to compute the results arising from use of any method required under the United States transfer pricing regulations for services and intellectual property transactions, including the services cost method, cost of services plus method, comparable profits method, comparable uncontrolled transaction method, comparable uncontrolled services price method, profit split method, residual profit split method, gross services margin method, and unspecified methods. An additional benefit is that the system can perform allocations based on time splits, with an unlimited number of available time segments, and can also apply a compound driver calculation, where the resulting allocations based on time splits (by recipient, geographic area, or other base) are further computed within each time split according to one or more drivers utilizing a driver pool comprised of the recipients within each time split. Another benefit is that the system can utilize an unlimited number of allocation drivers in a single computation. Another benefit is that the system can perform cascading allocations from one entity to another, with a true-up in between each allocation. Another benefit is that the system produces all computational detail for tax authorities that explain the computations for each charge to a recipient. An additional benefit is that the system can produce invoice billing reports for each recipient, itemized by charge and with billing detail including costs of services, mark-ups, and withholding taxes. Further benefits include tables that appear in the transfer pricing documentation report which provide the detail on driver pools and drivers, costs and mark-ups, and percentages of costs charged to affiliates and uncharged costs. Another benefit of the system is the ability to include multiple services providers and recipients in the same system, enabling a centralized computational exercise.

Thus, there has been summarized and outlined, generally in broad form, a plurality of the most important features of the present invention. While this summary is presented so that the novelty of the present contribution to the related art may be better appreciated, it will further be apparent that additional features of the invention described hereinafter (which will form the subject matter of the claims appended hereto) will further define the scope, novelty, and in certain instances the improvements upon any existing art. The following description provides specific details for a thorough understanding of, and enabling description for, various examples of the technology. One skilled in the art will understand that the technology may be practiced without many of these details and it is to be readily understood that the invention presented herein is not limited in its application to the details of construction and to the arrangements of the components set forth in the following description or illustrated in the various figures integrated and categorized herein. For example, in some instances, well-known structures and functions have not been shown or described in detail to avoid unnecessarily obscuring the description of the examples of the technology. It is intended that the terminology used in the description presented below be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section. Those skilled in the art will appreciate that the disclosure of the present invention may readily be utilized as a basis for the designing of other similar structures, methods and systems for carrying out the various purposes and objectives of the present invention. Thus, the claims as set forth shall allow for such equivalent constructions insofar as they do not depart from the spirit and scope of the present invention as described herein.

### BRIEF DESCRIPTION OF THE FIGURES OF THE PRESENT INVENTION

A further understanding of the present invention and the objectives other than those set forth above can be obtained by reference to the various embodiments set forth in the illustrations of the accompanying figures. Although the illustrated embodiments are merely exemplary of the present invention, apparatus and method of use of the invention, in general, together with further objectives and advantages thereof, may be more easily understood by reference to the drawings, examples, and the following description. The examples and figures are not intended to limit the scope of this invention, which is set forth with particularity in the claims as appended or as subsequently amended, but merely to clarify and exemplify the invention. The detailed description makes reference to the accompanying figures wherein:

FIG. 1 is a block diagram illustrating a suitable computing environment in which aspects of the technology may be implemented.

FIG. 2A is a block diagram illustrating the inputs and outputs of a cost allocation module.

FIG. 2B is a block diagram illustrating the inputs and outputs of a cost allocation module that includes an interface bridge.

FIG. 3 is a block diagram illustrating components of a cost allocation module.

FIG. 4 is a block diagram illustrating various process flows associated with automatically determining transfer prices.

FIG. 5 is a flow chart diagram illustrating an allocation of costs between various departments based on an allocation metric that may be determined through interviews.

FIG. 6 is a flow diagram illustrating known transfer pricing rules to determine arm's length services allocations including the steps of a services provider analysis and a services recipient analysis.

FIG. 7 is a sample calculation for a recipient and provider of a centralized administrative service.

FIG. 8A and FIG. 8B are flow diagrams illustrating a process for generating services transfer pricing computations.

FIG. 9 is a flow diagram depicting the process used to separate US and Foreign source income.

FIG. 10 is a flow diagram illustrating a routine for automatically generating transfer price documentation.

FIG. 11 is a display diagram illustrating an input screen for a cost allocation module.

FIG. 12 is a display diagram illustrating an output screen for a cost allocation module.

### DETAILED DESCRIPTION OF THE PRESENT INVENTION

A detailed illustrative embodiment of the present invention is disclosed herein. However, techniques of implementation and resulting structures in accordance with the present invention may be embodied in a wide variety of forms and modes, some of which may be quite different from those in the disclosed embodiment. Consequently, the specific structural details disclosed herein are merely representative, yet in that regard, they are deemed to afford the best embodiment for purposes of disclosure and to provide a basis for the claims herein, which define the scope of the present invention. The following presents a detailed description of several examples of the present invention.

Moreover, well-known methods, procedures, and substances for both carrying out the objectives of the present invention and illustrating the preferred embodiment are incorporated herein but have not been described in detail as not to unnecessarily obscure novel aspects of the present invention.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

Suitable Computing Environment

As described herein, the transfer price documentation generation system and various methods performed to automatically generate transfer price documentation may be part of various computing environments, such as computing environments that include computing resources associated with a company and its related service providers and service recipients, computing resources associated with accounting and other consulting firms providing assistance to the company, computing resources associated with tax departments and other regulatory entities, and/or computing resources associated with other related organizations.

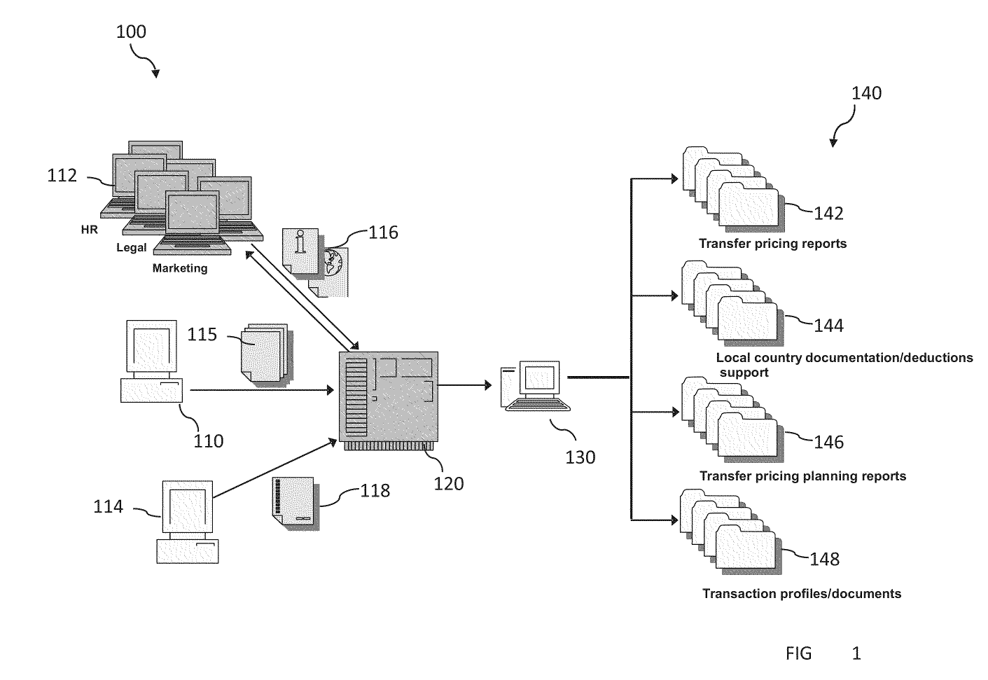

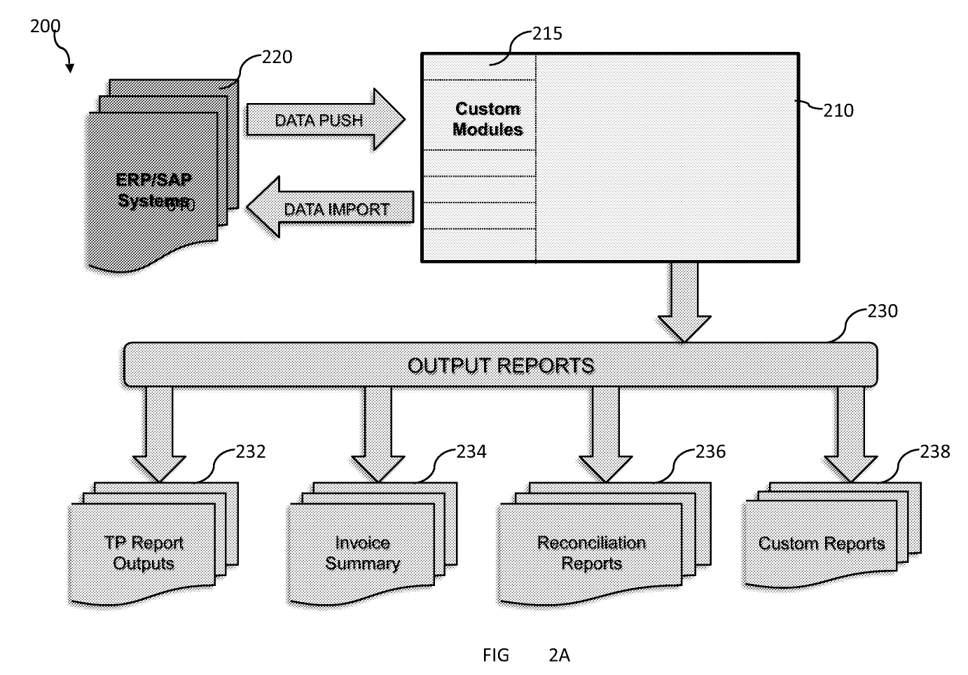

Turning to FIG. 1, a block diagram illustrating a suitable computing environment 100 in which aspects of the transfer price documentation system may be implemented is shown. Although not required, aspects of the system are described in the general context of computer-executable instructions, such as routines executed by a general-purpose computer, e.g., a server computer, wireless device or personal computer. Those skilled in the relevant art will appreciate that the system can be practiced with other communications, data processing, or computer system configurations, including: Internet appliances, network PCs, mini-computers, mainframe computers, and the like. Indeed, the terms “computer,” “host,” and “host computer” are generally used interchangeably herein, and refer to any of the above devices and systems, as well as any data processor.

Aspects of the system can be embodied in a special purpose computer or data processor that is specifically programmed, configured, or constructed to perform one or more of the computer-executable instructions explained in detail herein. Aspects of the system can also be practiced in distributed computing environments where tasks or modules are performed by remote processing devices, which are linked through a communications network, such as a Local Area Network (LAN), Wide Area Network (WAN), Storage Area Network (SAN), Fibre Channel, or the Internet. In a distributed computing environment, program modules may be located in both local and remote memory storage devices.

Aspects of the system may be stored or distributed on computer-readable media, including magnetically or optically readable computer discs, hard-wired or preprogrammed chips (e.g., EEPROM semiconductor chips), nanotechnology memory, biological memory, or other tangible data storage media. Indeed, computer implemented instructions, data structures, screen displays, and other data under aspects of the system may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the system reside on a server computer, while corresponding portions reside on a client computer, and thus, while certain hardware platforms are described herein, aspects of the system are equally applicable to nodes on a network.

The computing environment 100 includes an input server 110 configured to receive and/or map information 115, such as services costs by transfer pricing category or cost center, markup information based on the results of comparables research, and/or the results of functional analyses conducted to determine allocation methodologies, drivers, and adjustments, and relative value of services according to applicable United States transfer pricing regulations and non-US transfer pricing guidelines.

The input server 110 may assist with providing and/or mapping information from various information sources within the computing environment 100, such as questionnaire and/or reporting information 116 from various departments 112 within a company (i.e. human resources departments, legal departments, marketing departments, and so on), financial and/or business information 118 from tax departments 114, and other information.

The computing environment 100 also includes a transfer price determination server 120 configured to determine transfer prices by utilizing matrix multiplication to compute multiple-step allocations as required under United States transfer pricing regulations by service type, including use of multi-step, tiered, reciprocal, and time-based allocations, multiple blended allocation drivers and profit mark-ups, and/or recipient revenue, profit or cost, used as the base for commissions for high value services.

Further details regarding components of the transfer price determination server 120 and various techniques performed by the transfer price determination server 120 are discussed herein.

An output server 130, in communication with the transfer price determination server 120, produces outputs for multiple service providers and recipients, such as in response to a user command that include a single computational summary for all calculations by provider and recipient, with functional detail on each service and itemized invoice summaries that comply with value-added tax and tax-deductibility informational requirements in US and foreign jurisdictions, summaries of allocations and fees by type, and matrix tables for allocations by head office department and recipient tax (legal) entity.

The output server 130 may generate records 140 to be used as components of principal documents required under Section 1.6662 of the United States Internal Revenue Code to demonstrate contemporaneous compliance with transfer pricing regulations. The generated records 140 may include transfer pricing reports 142, local country documentation and/or deductions support 144, transfer pricing planning reports 146, transaction profiles/documents 148, and/or other reports.

Thus, in some examples of the preferred embodiments, the transfer pricing documentation generation may automatically generate transfer pricing documentation by utilizing an input server 110 that facilitates the collection and analysis of information from various entities within a company, a transfer pricing determination server 120 that automatically determines and/or calculates transfer prices for services provided by related entities within the company, and an output server 130 that generates reports 140 associated with the determined transfer prices.

Cost Allocation Modules

As described herein, in some examples, information associated with services provided between providers and recipients within a corporation and/or other enterprise may be input into a transfer pricing determination server 120, such as a server 120 that includes a cost allocation module or tool configured to automatically perform allocations based on the input information.

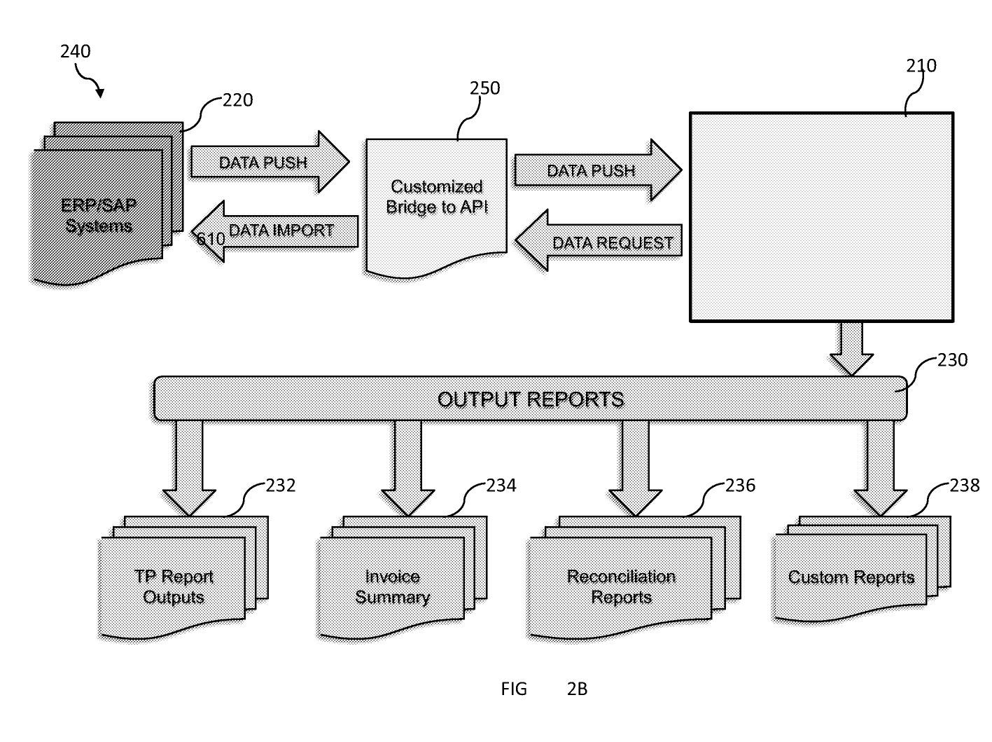

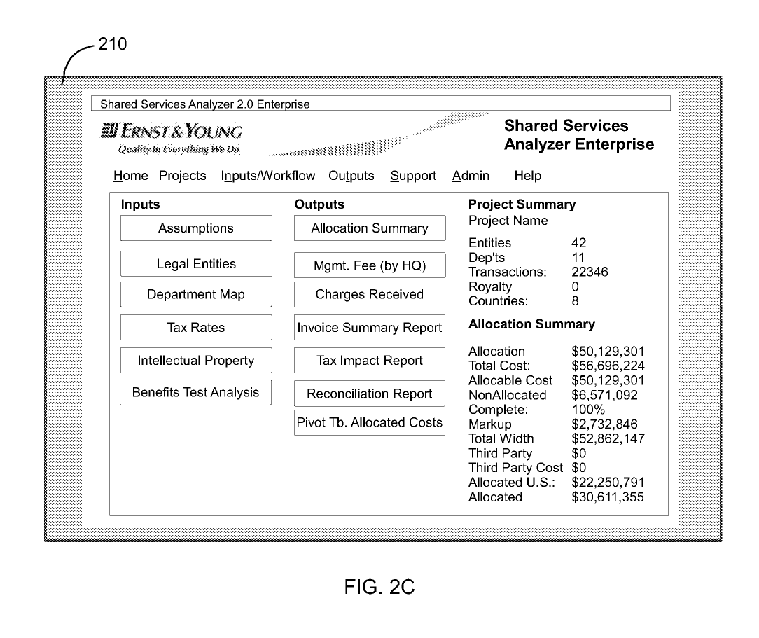

Referring to FIG. 2A, a block diagram 200 illustrating the inputs and outputs associated with a cost allocation module is shown. A cost allocation module 210 receives and/or imports data from various data management systems, such as an Enterprise Resource Planning (ERP) System 220. An ERP system generally includes software that integrates internal and external management information across an entire organization, including accounting information, manufacturing information, sales information, service information, customer information, and so on. An ERP system connects various components within an organization, and may include a database or other data repository that stores the management information. Additionally, the ERP system 220 may facilitate the communication of information to outside sources, such as to the cost allocation module 220 of the transfer pricing determination server 120, via Application Programming Interfaces (APIs), among other ways.

The cost allocation module 210 may include custom modules 215 configured to pull, import, and/or otherwise receive management information from the ERP system 220. That is, the cost allocation module 210 may include software modules 215 capable of communicating with the ERP system 220 via APIs published by the ERP system 220 in order to extract the management information stored therein.

The cost allocation module 210 may also export and/or output information, such as reports 230 that contain information based on allocations performed by the cost allocation module 210. For example, the cost allocation module 210 may export a variety of different reports 230, such as Transfer Pricing Reports 232, Invoice Summary Reports 234, Reconciliation Reports 236, Tax Impact Reports, Custom Reports, and so on.

In alternative embodiments, the cost allocation module 210 may utilize external interface components in order to import data from an organization. Referring to FIG. 2B, a block diagram illustrating the inputs and outputs of a cost allocation module 210 that includes an interface bridge 250 is shown.

In these embodiments, the cost allocation module 210 utilizes a interface bridge 250 to pull, import, and/or otherwise receive information from the ERP system 220. That is, the cost allocation module 210 communicates with the interface bridge 250, which communicates with the ERP system 220, when requesting and/or receiving information from the ERP system 210.

Thus, in some examples of the system, a cost allocation module 210 is configured to automatically import and/or otherwise receive information to be used in transfer pricing generation from an organization, such as from an Enterprise Resource Planning System, or other system that manages data for an organization.

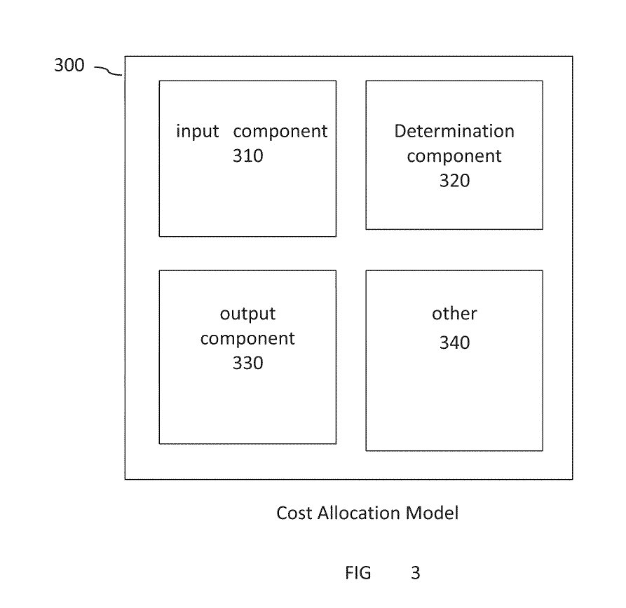

As described herein, the cost allocation module 210 may include software and/or hardware components configured and/or programmed to automatically perform allocations and generate transfer pricing for services provided between entities within an organization, such as a corporation or enterprise. Referring to FIG. 3, a block diagram illustrating components of a cost allocation module 300 is shown.

In some examples, the cost allocation module 300 includes an input component 310 configured to receive information from an organization, a determination component 320 configured to perform allocations and determine transfer pricing based on the received information and/or based on the performed allocations, an output component 330 configured to generate reports and other information, and other components 340 that facilitate the operation of the cost allocation module 300 and its components.

In some examples, the input component 310 is configured to automatically import or otherwise receive information from information management systems within an organization, such as ERP systems. That is, the input component 310 may include APIs that enable the cost allocation module 300 to communicate with other computing resources, such as other resources within computing environment 100.

In some examples, the determination component 320 is configured to automatically perform allocations and determine transfer prices for services provided within an organization. That is, the determination component 320 may perform multiple step allocations and calculate transfer prices using matrix multiplication techniques, as well as perform other routines or processes described herein.

In some examples, the output component 330 is configured to generate output information, such as reports or other documents, that provides details and descriptions supporting the various allocations and transfer prices performed and determined by the determination component 320. That is, the output component 330 may automatically generate and output transfer-pricing documentation in response to a request received from a user to perform allocations for services provided within an entity, among other things.

In addition, in some examples, the cost allocation module 300 includes other components 340, such as components that provide user interface screens or other displays to users of the system, components that enable the cost allocation module 300 to communicate with other computing resources within a computing environment, memory or other storage components, and so on.

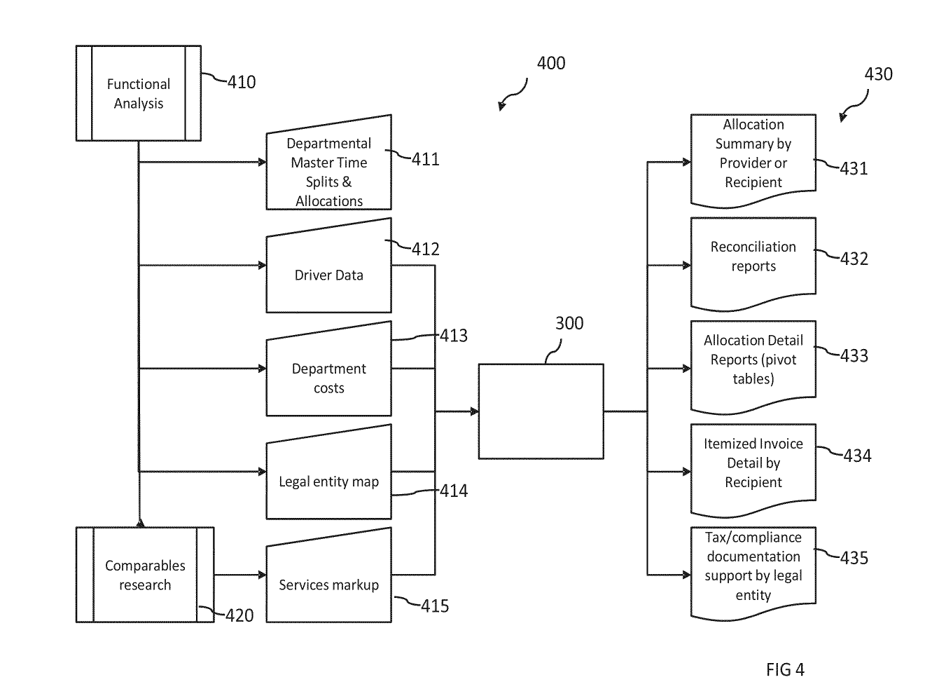

As described herein, the cost allocation module 300 utilizes various inputs in order to automatically determine transfer prices for services within a company and generate documentation associated with the determined transfer prices. Turning to FIG. 4, various flows of information 400 associated with automatically determining transfer prices and generating associated documentation are shown.

The system may employ a functional analysis component 410 that utilizes various processes to document the services provided between related entities, their costs, benefits, and so on, as described herein. For example, the processes may determine service cost calculations while satisfying contemporaneous documentation requirements of many developed countries in which service provider entities operate and/or are located. That is, the functional analysis component 410 provides a very detailed analysis of the operations of a company, which assists transfer-pricing professionals to accurately calculate the transfer prices of services that are charged to the service recipients within the company.

The processes performed by the functional analysis component 410 may include interviews with service provider personnel, interviews with service recipient personnel, and/or interviews with other personnel within the company. The interviews function to define the provided services, define the recipients, outline the benefits of the services to the recipients, determine if there are any non-allocable portions of the services, determine which business drivers impact the performance and benefit of the services, and/or determine the relative share of the benefits to each of the recipients. One of the outcomes of the interviews will be information associated with departmental and master time splits 411, which facilitates an initial allocation to various recipients of provided services.

The functional analysis component 410 facilitates a logical and accurate allocation of the costs of a department to the recipient entities. Because it is unlikely that a service provider department that benefits multiple entities will have their time equally and/or easily determinable to the recipient entities, interviews are performed, often with each member of the department (or at the very least, the department leaders), to determine the allocation. Often, various tracking processes, such as timesheets, may be examined in parallel to the interviews. In many cases, the interview seeks to aggregate time spent on a macro level, such as aggregate the time spent based on geography, operating company, division, or other logical macro breakdowns. For example, if a headquarters business development function or service affects and benefits hundreds of geographic entities, it may be difficult to parse the time spent at such a high level, and the interviewer may seek other levels.

Thus, the functional analysis component 410 determines an outcome for allocations such as the following, which is an example table for a US-based multinational Controller and her department:

TABLE 1
Allocation of Time for Controller Department.

| | | Operating companies or product lines | | | | | | | | |
|---|---|---|---|---|---|---|---|---|---|---|
| No. | Controller Department | Div 1 | Div 2 | Geog 1 | Geog 2 | Geog 3 | Geog 4 | Geog 5 | Stewardship | Notes |
| 1 | Controller | 50.0 | 50.0 | 25.0 | 30.0 | 20.0 | 20.0 | 20.0 | 25.0 | |
| 2 | Assistant Controller | 50.0 | 50.0 | 25.0 | 30.0 | 20.0 | 20.0 | 20.0 | 25.0 | |
| 3 | SEC Reporting Manager | 0.0 | 0.0 | 0.0 | 0.0 | 0.0 | 0.0 | 0.0 | 240.0 | |
| 4 | SOX Resource | 0.0 | 0.0 | 0.0 | 0.0 | 0.0 | 0.0 | 0.0 | 240.0 | |
| 5 | Finance/Holdings | 0.0 | 0.0 | 120.0 | 60.0 | 0.0 | 15.0 | 25.0 | 20.0 | |
| 6 | Accounts Payable | 0.0 | 0.0 | 120.0 | 30.0 | 30.0 | 30.0 | 30.0 | 0.0 | |
| 7 | Business Analysis Manager | 120.0 | 120.0 | 0.0 | 0.0 | 0.0 | 0.0 | 0.0 | 0.0 | |
| 8 | Business Analyst | 60.0 | 30.0 | 10.0 | 10.0 | 60.0 | 30.0 | 40.0 | 0.0 | |
| | Total Time (days) | 280.0 | 250.0 | 300.0 | 160.0 | 130.0 | 115.0 | 135.0 | 550.0 | 1,920.0 |
| | Total Time (%) | 14.6% | 13.0% | 15.6% | 8.3% | 6.8% | 6.0% | 7.0% | 28.6% | 100.0% |

In this process a 240 day calendar for the year is assumed, which represents 52 weeks times 5 days a week, or 260 days, less 20 days off work for vacation and holidays. It may also be based on a percentage, as the final line of data converts allocation results to a percentage allocation by recipient division or geography.

In the example reflected in Table 1, it can be deduced from the interviews that the Controller spent approximately 90% of her time performing allocable or chargeable services, and that she was allocated across two divisions and five geographies, which could represent many legal entities in several jurisdictions. In other words, the benefit of her activity is felt at legal and/or operational entities in several divisions and geographies. This information will be necessary in order to perform the benefits testing portion of the functional interviews in order to complete the local recipient tax and transfer pricing documentation, among other things.

In contrast, the SOX resource, the fourth row in the table, performs all of her time with activities in compliance with the Sarbanes-Oxley legislation that resulted from the accounting improprieties after Enron and similar collapses (the “Stewardship” column). Such activities would be deemed to be for the benefit of the shareholder, or in compliance with local regulations, and not beneficial to an entity outside of the country, as the benefit is either too remote or something that a local entity would not pay for unless it were required by law. Therefore, these charges would not be allocable and are noted as such in the stewardship column.

Thus, an allocation table may provide a summary of time-based allocations for an entity or department providing services, such as the fictional entity reflected in Table 1, as determined by interviews performed in accordance with the functional analysis component 410.

With respect to the cost allocation module 300, the functional analysis component 410 may facilitate interviews that gather information associated with a back-end benefit of analysis and calculation data. This information may include underlying business driver data 412 at a legal entity level, such as headcount data, sales data, production volume data, and so on. The data 412 may be received by the transfer price determination component 320 and utilized when performing certain allocation calculations, as described herein.

For example, after interviews performed in accordance with the functional analysis component 410 have concluded, each department will have a master time split, such as the one shown in Table 1. The master time split data may be transmitted and/or entered into the transfer price determination component to be utilized during the determination of transfer prices for services, as described herein. Information associated with driver data may now be collected. For example, interviews may collect data associated with overall headcount numbers, sales revenues by legal entity, and so on, as well as information related to the business drivers that are closely correlated to the services in question.

Referring back to the fictional department reflected in Table 1, the interviews and subsequent analysis may determine that the Controller spends more time benefiting larger entities that sell and/or produce more products, which may lead to the application of multiple drivers to the service cost allocations shown in the Table. If the determination is made that revenues and production volumes are the logical drivers that affect the time-spent for a particular entity, then that data may also be transmitted to the cost allocation module 300, which utilizes the received driver data to calculate the allocations for the particular entity.

Following the example of Table 1, if 50 days per year, or approximately 21% of the Controller's time, benefits the entities that are in Division One, then 21% of her costs are allocated to these entities based on the drivers of sales and production volume. If there are 10 entities in this particular division, then entity 1 is given its share of the 21% based on its total share of revenue for the division and its share of production volume for the division. Table 2 provides a summary of such an allocation:

TABLE 2
Allocation of Costs based on Benefit to Entity

| | | Percentage of | | Volume in | Percentage of | | Percentage of |
|---|---|---|---|---|---|---|---|
| Entity | Sales | Total Sales | Weighting | tons | Total Volume | Weighting | total allocation |
| Entity 1 | 1233 | 12.7% | 33.3% | 0 | 0.0% | 66.7% | 4.2% |
| Entity 2 | 345 | 3.5% | 33.3% | 2355 | 16.0% | 66.7% | 11.9% |
| Entity 3 | 12 | 0.1% | 33.3% | 3444 | 23.5% | 66.7% | 15.7% |
| Entity 4 | 6 | 0.1% | 33.3% | 7656 | 52.2% | 66.7% | 34.8% |
| Entity 5 | 56 | 0.6% | 33.3% | 0 | 0.0% | 66.7% | 0.2% |
| Entity 6 | 555 | 5.7% | 33.3% | 0 | 0.0% | 66.7% | 1.9% |
| Entity 7 | 6521 | 67.0% | 33.3% | 0 | 0.0% | 66.7% | 22.3% |
| Entity 8 | 455 | 4.7% | 33.3% | 0 | 0.0% | 66.7% | 1.6% |
| Entity 9 | 123 | 1.3% | 33.3% | 1222 | 8.3% | 66.7% | 6.0% |
| Entity 10 | 432 | 4.4% | 33.3% | 0 | 0.0% | 66.7% | 1.5% |
| Total | 9738 | 100.0% | | 14677 | 100.0% | | 100.0% |

As an example, Entity 1 accounts for approximately 13% of all sales for the Division; however it only receives a total of 4.2% of the total costs, because the Controller's time is also positively correlated to entities in the division that produce, with a production business driver being weighted ⅔ to ⅓ over the sales driver, based on the interviews performed in accordance with the functional analysis component 410.

The performed interviews may collect other information, such as information associated with fully loaded department cost data 413, legal entity map data 414, with legal names, addresses, and finance/accounting tax contacts for the recipient entities, and so on.

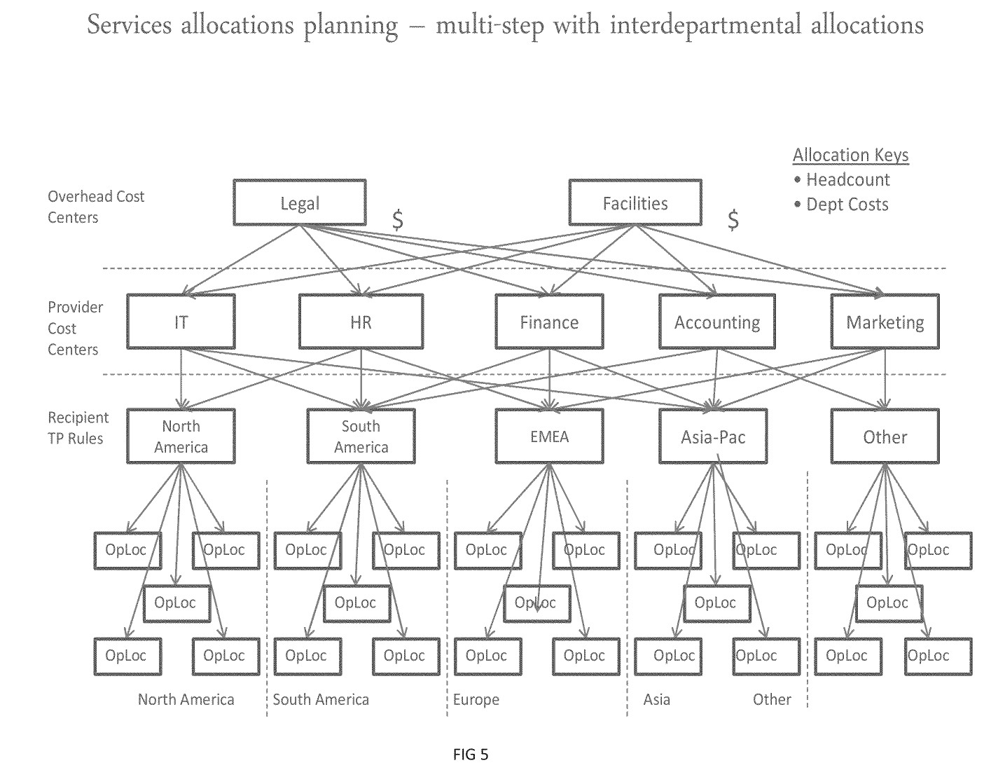

For example, the interviews may be performed in order to obtain information associated with fully loaded costs 413 for each department having allocable services. Based on the method in which the company accounts for its services costs, the obtained costs may be utilized during calculation of the charges to the legal entities. Additionally, information associated with a legal entity map 414 may be gathered during the initial interview process. The map includes entities at the lowest level that receive or will receive a charge for services from a service providing entity. The legal entity map also includes the service provider entities. For example, the flow chart diagram labeled FIG. 5 presents an allocation of costs between various departments based on an allocation metric that may be determined through interviews. As seen in this example, the allocation includes overhead cost centers and provider cost centers which are then allocated among various geographic and further removed departments.

In addition to the functional analysis component and associated techniques for information collection and analysis, the system may also employ a comparables research component 420 that is utilized to determine the arm's length charge for services performed within the company. In some cases, the process of determining the arm's length charge is to markup 415 the total services costs, where the markup represents the return that a similar service provider would achieve in providing similar services to third parties. A combination of the markup 415 added to the services costs represents the allocable cost to the service recipients.

In some cases, high value services may be charged to recipients based on a percentage of a driver such as sales. The same system can also generate a payment for use of intangible property such as a royalty. Usually, the charge is generally based on sales, which is captured in the driver data collection process described herein. In these cases, the royalty rate is also determined by a comparables exercise, looking at third party royalty rates for similar services. The royalty percentage may be analyzed, with any recorded sales driver data generating a royalty charge from the provider to the recipient. This information may be transmitted to the transfer price determination component 320, which may calculate step-royalty or graduated royalty charges based on data provided by customers.

For example, there may be a royalty of 0% for sales up to 100, and 2% for sales from 100 to 1000, and 4% for sales above that number. This graduated royalty may be customized by the service provided, and justified by an economic financial analysis and comparables analysis, which corroborate the arm's length nature of such a charge.

There are numerous outputs that are generated as a result of the processes performed by the transfer price documentation system. The processes enable the quick and efficient determination of detailed charges and breakdowns by legal entity, enable the quick and efficient correction of cost bases when legal entities are added or subtracted, and/or enable other benefits.

In sum, the system described herein facilitates determining costs and charges at a departmental level, with the determined costs and charges assigned to recipients at a legal entity level based on driver data and estimates of time spent at aggregate levels. That is, no charges are produced at the aggregate level. For example, although North America may be a logical level for a department to aggregate its time, the system breaks down the time allocation to a legal entity level for all of the entities that are classified under North America.

The outputs 430 of the system may be in the form of several reports and data that allow local entities to support their local transfer pricing reporting requirements while providing them support for their accounting and tax procedures. That is, the outputs 430 of the system are generated transfer price documentation that support entities taking expenses as local business tax deductions. Example outputs may include the following, although one of ordinary skill in the art will realize other forms are possible:

Allocation Summaries by Provider or Recipient 431—This report shows the overall allocation for each charge, whether it is a cost-based or royalty-based allocation. It is effectively a break-down of each service, the amount of the charge for that service, the markup applied, and so on. The Allocation Summary may be very useful to local tax authorities to justify the legal entity taking a business deduction for this expense;

Reconciliation Reports 432—This report shows every computation in the system behind each charge to an entity. This includes the identification and sum of each driver pools and the recipient entity portion for each driver, the time splits by department, mark-up, allocable percentage, and any discount by recipient for less than a full benefit. The Reconciliation Report may be very useful to local tax authorities to justify the computations in order to take a business deduction for the allocations;

Allocation Pivot Tables 433—These reports are pivot table spreadsheets that can break down the charges from the perspective of the service provider to each legal entity recipient. Based on the data in the legal entity map, there are additional geographic breakdowns and other ways to analyze and view the data;

Itemized Invoice Detail Reports 434—These reports provide invoice detail by line item and sub-line item as necessary including the cost and markup for each charge by department, and other identifying information including the date of the charge, the provider and recipient, and the contract number pursuant to which the services were provided, and addresses and other contact details for both the recipient and provider, as well as supporting explanatory comments describing each service performed and any notes on the service. The Invoice Summary Report may be very useful to local tax authorities in the areas of customs, Value Added Tax (VAT) and withholding tax, in establishing the appropriate levels of tax to apply to the charges, and to justify the deduction of the expenses by the recipient;

Tax Impact Reports 435—This report provides the gross tax impact by charge for both recipient and provider entity, including withholding taxes for payments for services and use of intangibles, and the resulting net tax impact on a worldwide basis; and so on.

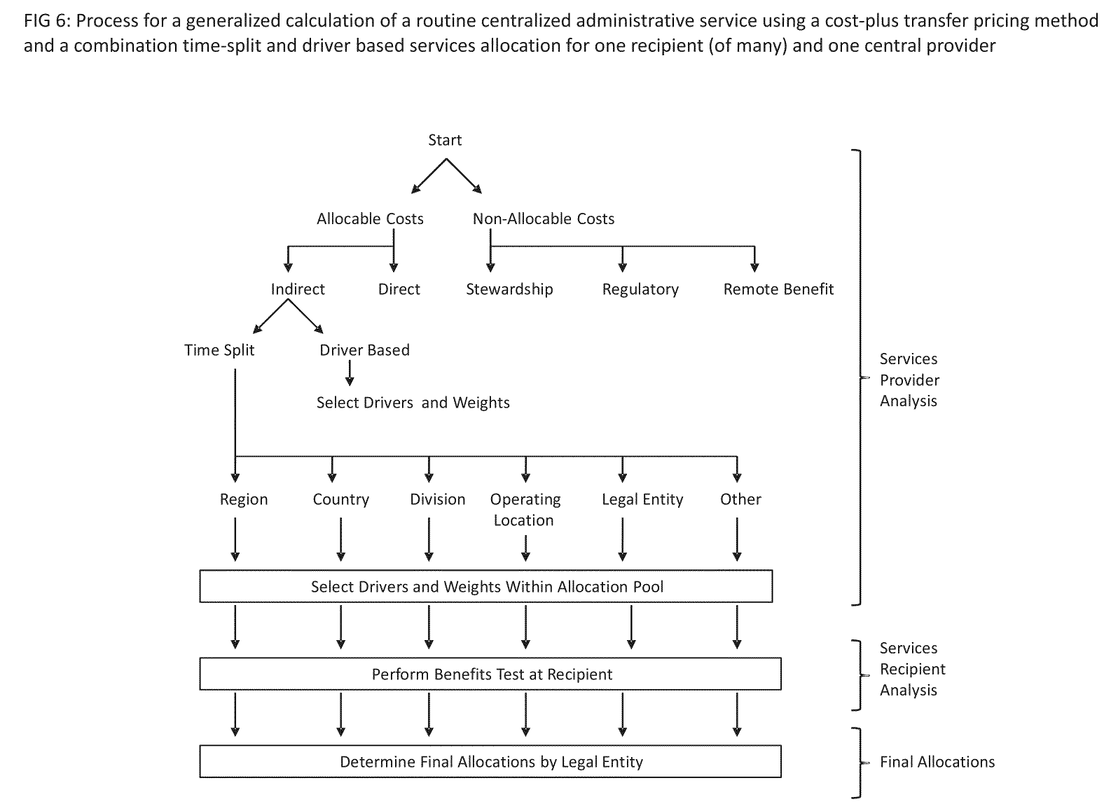

By way of reference, a flow diagram illustrating known transfer pricing rules to determine arm's length services allocations including the steps of a services provider analysis and a services recipient analysis is presented in FIG. 6. In short, this is a generalized process required in accordance with regulations promulgated by the United States and international corporate tax and/or transfer pricing rules, guidelines and/or regulations. As presented, a cost-plus transfer pricing method and a combination time-split and driver based services allocation results in the calculation of final allocations by legal entity.

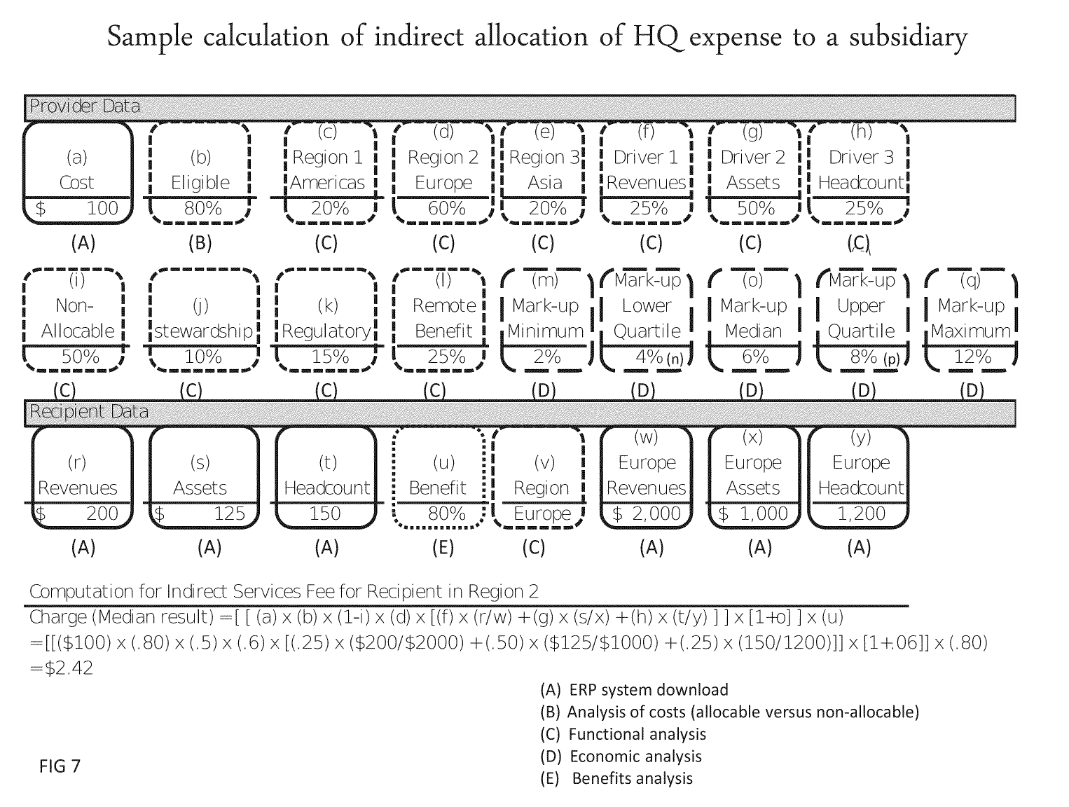

FIG. 7 represents a sample calculation for a recipient and provider of a routine centralized administrative service. The system may employ a cost-plus transfer pricing method. This calculation could have many variations depending on the fact pattern, such as a time-split only allocation, or a driver-only calculation, with or without a mark-up, or possibly a benefits based calculation, and may utilize one of six specified transfer pricing methods for controlled services identified under the U.S. Treasury Regulation 1.482-9 for services or other code or regulation sections for intangible property, or a combination thereof.

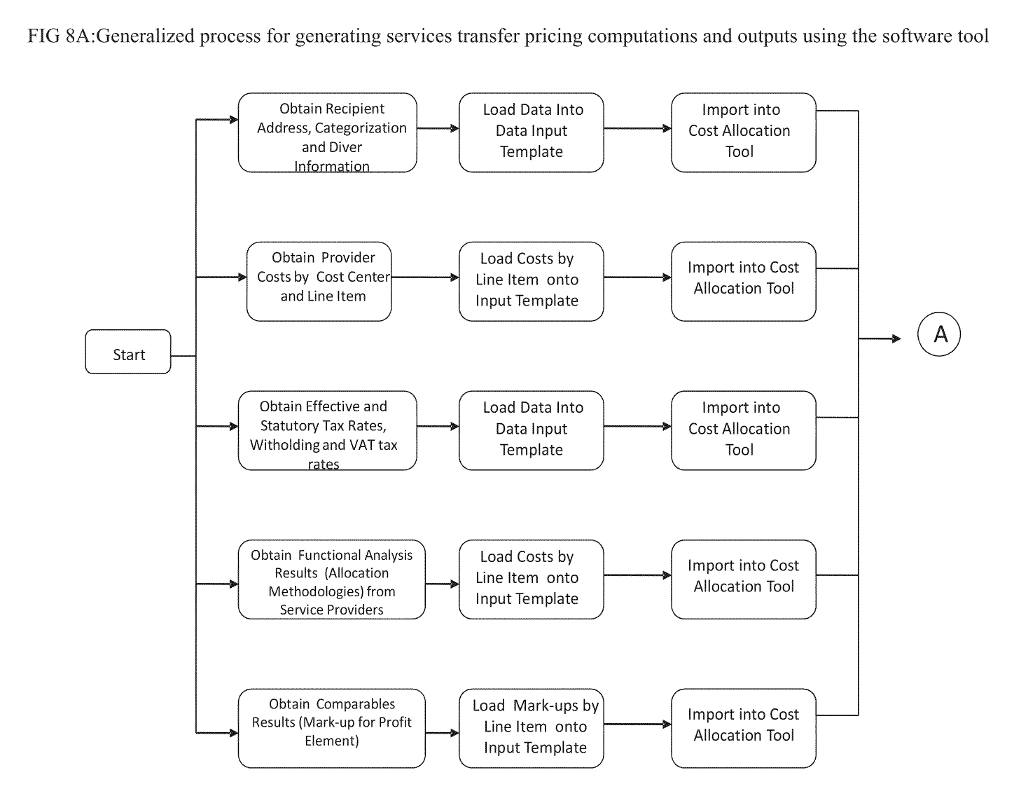

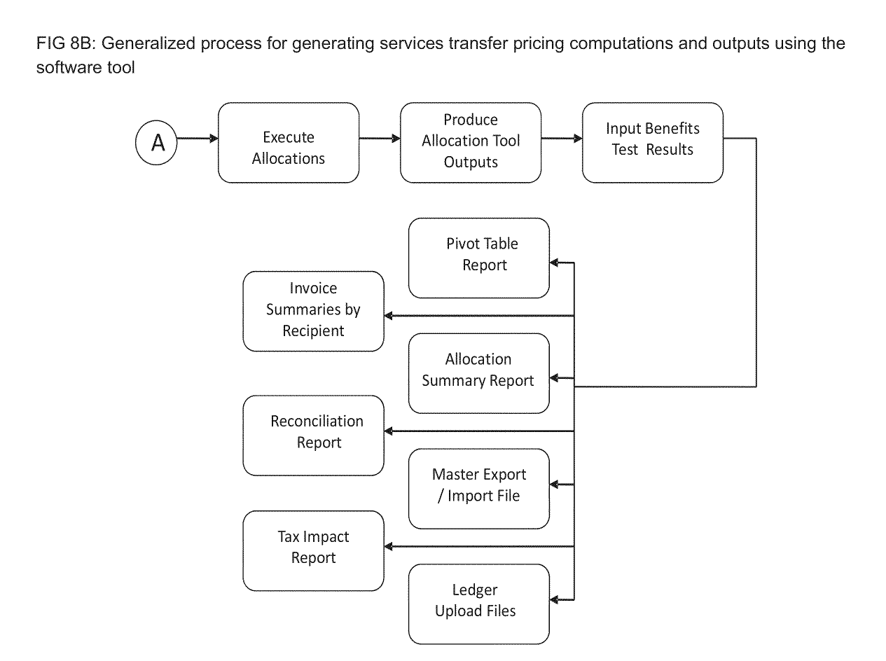

The system may perform a process for generating services transfer pricing computations. This process is depicted in flow diagrams labeled FIG. 8A and FIG. 8B. Depicted are the inputs and steps required to utilize the system to accomplish the required steps in order to comply with the computational requirements of the US Section 1.482-9 transfer pricing regulations. The information is gathered either manually for entry into importable spreadsheets, graphical user interfaces, or can be imported into the system directly from other financial, operational, and accounting systems. The system performs the calculations automatically based on commands by the user. The user can then direct the system to export the outputs to the company's financial accounting software, or produce paper copies or digital copies of outputs for use by both services provider and recipients for transfer pricing documentation purposes.

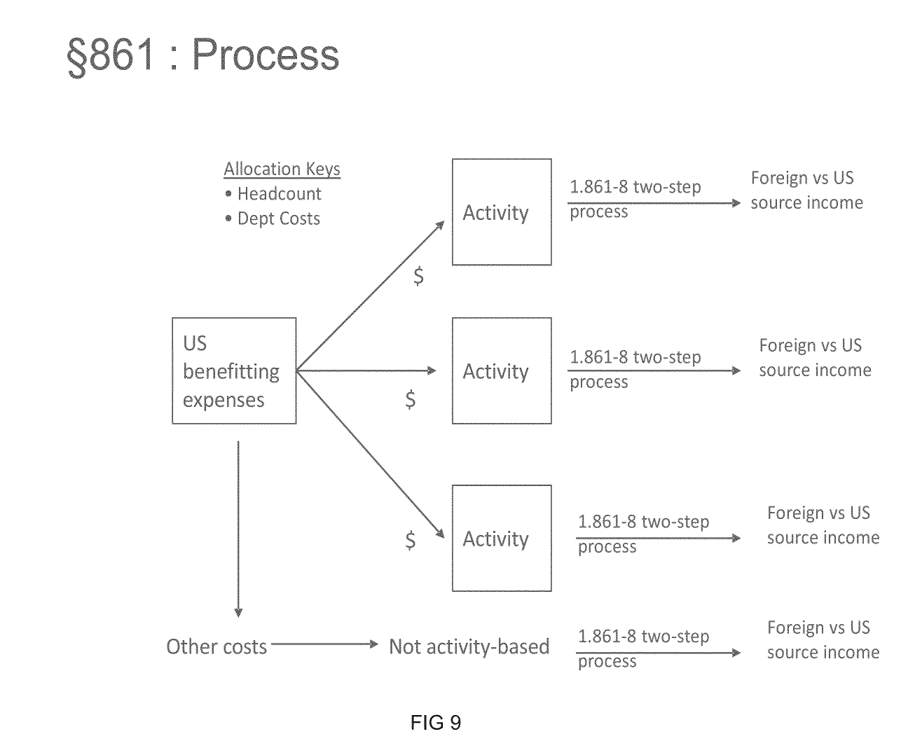

The system may perform a process for performing US Section 861 computations. The process to separate US and Foreign source income is depicted in the flow diagram labeled FIG. 9. Depicted are the inputs and steps required to utilize the system to accomplish the required steps in order to comply with the computational requirements of the US Section 861 regulations. The information is gathered either manually for entry into importable spreadsheets, graphical user interfaces, or can be imported into the system directly from accounting systems. The system performs the calculations automatically based on commands by the user. The user can then direct the system to export the outputs to the company's financial accounting software, or produce paper copies or digital copies of outputs for use by both services provider and recipient for transfer pricing documentation purposes.

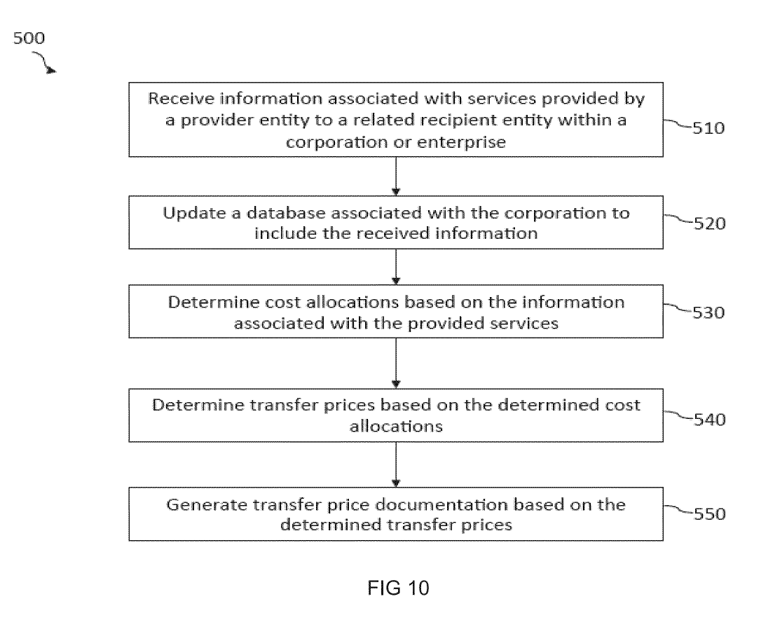

As described herein, the system may utilize a cost allocation module or other tool when performing and/or determining automatic allocations, in order to generate transfer price documentation for services provided within an organization, among other things. Turning to FIG. 10, a flow diagram illustrating a routine 500 for automatically generating transfer price documentation is shown.

In step 510, the system receives information associated with services provided by a provider entity to a related recipient entity within a corporation. Various inputs may provide the information to the system. Functional analysis components, described in detail herein, may provide the system with information associated with provided services, such as costs, benefits, business driver information, and so on. For example, the input component 310 of the cost allocation module 300 may facilitate the reception of the information associated with the provided services by communicating with APIs of an information management system for the corporation.

In step 520, the system updates, modifies, and/or creates a database associated with the corporation to include the received information. The system may update the database by creating a cost base within the database that contains the costs associated with each service provider. Each created cost base may include records or entries of individual cost categories for the cost base, based on categories required by relevant transfer pricing guidance and/or may include records or entries for each individual eligible services recipient, including values of services drivers deemed appropriate during the functional analysis of each service, as well as information related to one or more relevant driver pools to which the recipient belongs, for purposes of transfer pricing allocations.

In some cases, the system may create and/or utilize various templates, and store information in template form within the database. That is, the system may utilize a data input template when inputting different types of data into databases, may utilize an input that provides line item entry of various types of data, or may utilize other input templates when inputting and/or organizing received information within tables or data structures stored in the database.

In step 530, the system automatically determines one or more cost allocations based on the received information. For example, the determination component 320 of the cost allocation module 300 may perform a variety of different techniques when performing allocations. Some of these techniques may include and/or employ the following steps:
automatic calculations and other performance in response to the input of information and/or selections from a menu of operations;
identification of service categories as being allocable or non-allocable;
identification of non-allocable costs by non-allocable category, such as stewardship, regulatory, duplicative, or remote benefit categories;
applying one or more weighted drivers;
applying one or more combinations of weighted drivers;
applying allocation methodologies by line item within an entity or center;
performing multiple stage allocations for a service which cascades up or down within layers of service providers (such as a corporate legal charge that cascades from corporate to regional to divisional head office before allocation to entities within the particular region and division);
performing multiple stage allocations for a service using matrix multiplication;
performing sequential two-step allocations using time splits and then driver-based allocations within each time split;
performing upward allocations from any legal entity to another within an organization;
performing downward allocations from any legal entity to another within an organization;
performing lateral allocations from any legal entity to another within an organization;
performing single department allocations that include multiple input types, such as multiple service types, multiple markups, and so on;
performing allocations based on location and/or division within an organization; and so on.
performing allocations of costs according to a cost sharing arrangement;
performing royalty or license fee computations as a percentage of total revenues;
performing royalty or license fee computations as a percentage of a segment of revenues;
performing multiple royalty or license fee computations as a percentage of a segment revenues;
performing multiple royalty or license fee computations as a percentage of a segment revenues and then consolidating as a single royalty amount or percentage;
performing royalty or license fee computations as a percentage of any non-revenue driver;
performing multiple royalty or license fee computations as a percentage of any segment non-revenue drivers;
performing multiple royalty or license fee computations as a percentage of a segment non-revenue drivers and then consolidating as a single royalty amount or percentage of selected driver;
performing a royalty or license fee computations which moves dynamically according to pre-defined rules, including minimum recipient profitability and/or maximum royalty amount, and/or which impacts recipient profitability in a manner that is correlated with the directional vector of revenues, and/or which otherwise maximizes or minimizes an objective function constructed from the above or other rules;
performing a royalty or license fee computations that moves dynamically to leave the recipient with a fixed amount of transactional profit or profit percentage (residual royalty);
performing a computation of the transfer price that splits the total profit between the recipient and the provider of the service or intangible according to a predetermined percentage;
performing a computation of the transfer price that splits the residual profit between the recipient and the provider of the service or intangible according to a predetermined percentage after subtracting the routine profit from the profit split computation;
performing a computation of transfer prices for services or intangibles according to any other method which uses a numerator and denominator.

Of course, one of ordinary skill in the art will appreciate that the cost allocation module enables the system to perform some or all of the allocation techniques described herein as well as other techniques known in the art.

In step 540, the system determines transfer prices based on the performed allocations. For example, the system may perform a variety of calculations, such as matrix multiplication, when determining transfer pricing for services based on performed allocations.

In step 550, the system generates transfer price documentation based on the determined transfer prices. For example, the system may generate transfer pricing reports, local country documentation and/or deductions support documentation, transfer pricing planning reports, transaction profiles/documents, and/or other reports required under the various transfer pricing regulations and codes described herein.

Therefore, in some examples of the preferred embodiment, the transfer pricing documentation generating systems facilitates the automatic determination of transfer prices for services provided between related entities within a corporation, which facilitates simplifying what is conventionally a manual and data intensive transfer pricing compliance exercise. That is, by establishing a computing environment, cost allocation module, and various processes within the computing environment, the system may connect directly with service provider tax accounting and data repository computing resources (e.g. ERP systems) for various needed inputs and information, which facilitates the automatic determination of transfer prices for provides services, and, thus, a simplified, less labor intensive, and/or automatic generation of transfer pricing documentation, among other benefits.

The following screen shots illustrate example input and output screens presented by the cost allocation module that facilitate the automatic determination of transfer pricing documentation, among other things.

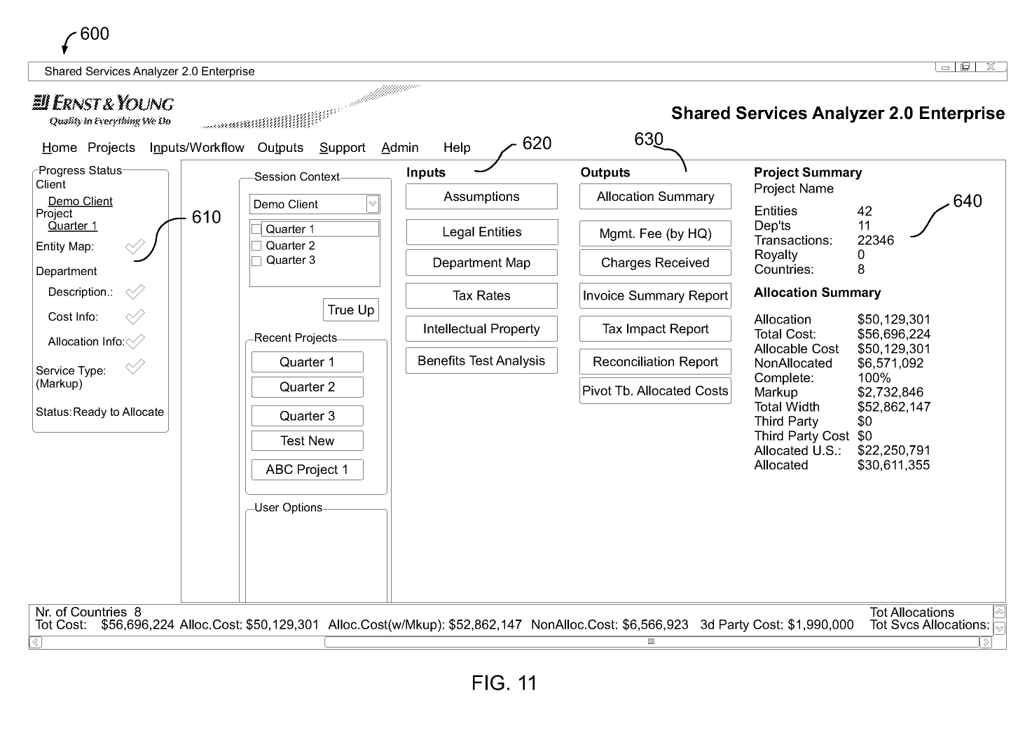

Turning to FIG. 11, a display diagram illustrating an input screen 600 for a cost allocation module 300 is shown. The input screen 600 includes a service information section 610 that shows the types of information received by the cost allocation module to be allocated when determining transfer pricing. For example, the service information section 610 confirms that entity map information, department description information, cost information, allocation information, and service type, or markup information, has been received and stored in databases associated with cost allocation module 300. Furthermore, the service information section 610 may show the status of received information, in this case that the received information is ready to be utilized by allocation techniques.

The input screen 600 also includes an input selection section 620 and an output selection section 630, which enable users of the cost allocation module 300 to select the types of information to input and/or the types of reports to generate, respectively, before and after the system automatically generates transfer prices for services provided within an organization.

The input screen 600 also includes a project summary section 640, which provides various information associated with the calculations, allocations, and/or determination performed by the cost allocation module 300. For example, the project summary section 640 of FIG. 11 presents information associated with a provided service, indicated as a “project,” within the organization. This information may include project information, such as a number of entities associated with the project, a number of departments associated with the project, a number of transactions performed within the project, any royalties associated with the project, a number of countries associated with the project, as well as allocation information, such as an allocation amount, a total cost amount, an allocable cost amount, a non-allocable cost amount, a markup amount, a withholding amount, any third party costs, and other allocation and/or transfer pricing information.

Thus, the input screen 600 may include sections that facilitate the input, output, and/or presentation of information associated with a service provided by an organization, such as information used to perform allocations, information used to support transfer-pricing determinations, and/or information generated during the performance of allocations, among other things.

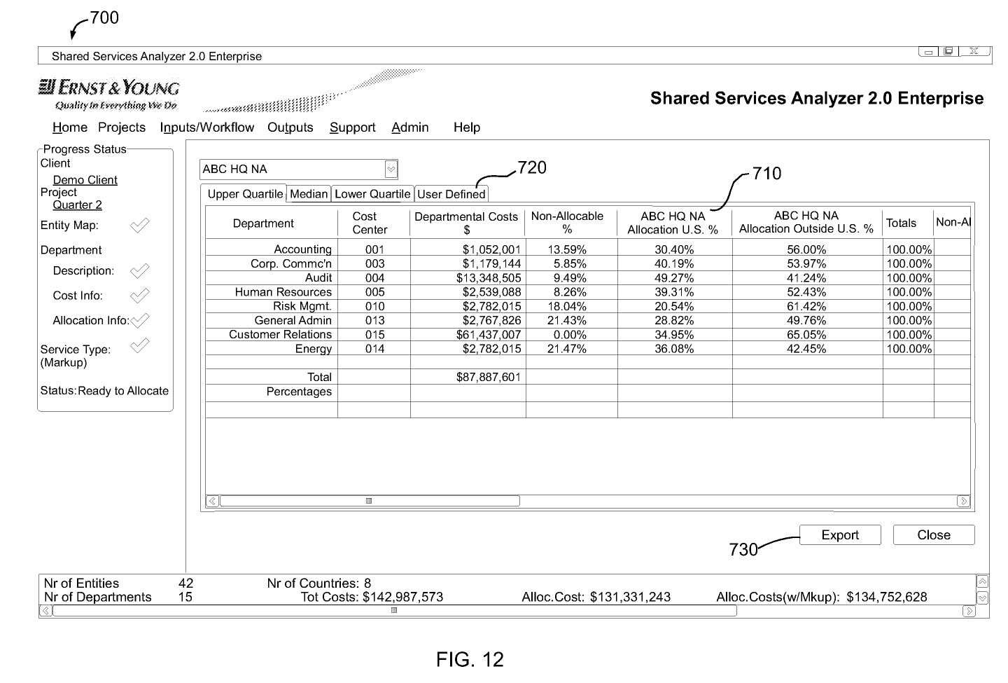

Turning to FIG. 12, a display diagram illustrating an output screen 700 for a cost allocation module 300 is shown. The output screen 700 may include information and sections shown in FIG. 12, such as input or output information.

The output screen 700 also provides a summary 710 of allocations across an organization, such as a spreadsheet reflecting a breakdown of allocations for each department within an organization. The output screen may include tabs 720 or other graphical elements that enable users to select a specific summary, such as a summary based on upper or lower quartiles, or other system or user-defined criteria.

For example, the summary 710 provided by the output screen 700 may include a breakdown of allocations for different departments, such as accounting departments, communication departments, audit departments, human resources, risk management departments, customer relations departments, energy departments, and so on. The summary may present allocation information that reflects the cost center, the overall department costs, the allocable costs, the non-allocable costs, and so on.

Thus, in some examples, the cost allocation module 300, via user interfaces, such as screen shot 600, 700, or others not shown in the Figures, enables users of the system to select the types of information to be used in performing allocations, to select when allocations are performed, to select the types of reports and other information that are generated, and so on. The user interface enables users to have a transparent, user-defined experience during the generation of transfer pricing documentation, while still removing the burdensome task from users of actually performing the allocation techniques and other calculations in creating the documentation themselves, among other benefits.

### Example Calculations for Services in an Organization

The following calculation is that of a single services allocation from one cost center to one recipient, utilizing a split of the executives' time by geographic region, combined with multiple custom-weighted allocation drivers reflecting how the fee should be split between legal entities within each geographic region. In the diagram below the following variables are shown:
(a) Total cost of the department, including fixed and variable compensation (including stock based compensation) and overhead;
(b) Costs eligible to be allocated, based on a review of the costs in (a) by line item, in order to eliminate certain costs such as charity, political contributions, fines, and other costs that generally are not eligible for allocation;
(c)-(e) Average split of the department's allocable time based on functional analysis interviews;
(f)-(h) Allocation keys determined to be the most correlated with the recipient benefit based on functional analysis and recipient benefits test;
(i) Total cost determined to be non-allocable based on functional analysis interviews;
(j)-(l) Proportion of non-allocable costs reported in (i) by category based on functional analysis interviews (this specific identification is generally required under Regulations section 1.482-9(l)(3));
(m)-(q) Comparables range of mark-ups based on economic analysis by service type;
(r)-(t) Value of allocation keys in ((g)-(h) for the entity being charged (in this case a European entity);
(u) The proportion of the allocation sustained by the recipient benefits test;
(v) Identification of the driver pool in which the recipient is a member (in this case a regional driver pool);
(w)-(y) Value of the combined allocation keys for all entities in the driver pool.

The calculations shown below compute the allocation to one European legal entity at the median result.

TABLE 3
Provider Data

| | | (c) | (d) | (e) | (f) |
|---|---|---|---|---|---|
| (a) | (b) | Region 1 | Region 2 | Region 3 | Driver 1 |
| Cost | Allocable | Americas | Europe | Asia | Revenues |
| $100.00 | 50% | 20% | 60% | 20% | 25% |

| (g) | (h) | (i) | | | (l) |
|---|---|---|---|---|---|
| Driver 2 | Driver 3 | Non- | (j) | (k) | Remote |
| Assets | Headcount | Allocable | Sstewardship | Regulatory | Benefit |
| 50% | 25% | 50% | 10% | 15% | 25% |

| | (n) | | (p) | |
|---|---|---|---|---|
| (m) | Mark-up | (o) | Mark-up | (q) |
| Mark-up | Lower | Mark-up | Upper | Mark-up |
| Minimum | Quartile | Median | Quartile | Maximum |
| 2% | 4% | 6% | 8% | 12% |

Recipient Data

| (r) | (s) | (t) | (u) | (v) |
|---|---|---|---|---|
| Revenues | Assets | Headcount | Benefit | Region |
| $200.00 | $125.00 | 150 | 80% | Europe |

| (w) | (x) | (y) |
|---|---|---|
| Europe | Europe | Europe |
| Revenues | Assets | Headcount |
| $2,000.00 | $1,000.00 | 1,200 |

Computation for Recipient Charge
Charge (Median result) = [[(a) × (b) × (d) × [(f) × (r/w) + (g) × (s/x) + (h) × (t/y)]] × [1 + o]] × (u) = [[($100) × (.50) × (.10) × [(.25) × ($200/$2000) + (.50) × ($125/$1000) + (.25) × (150/1200)]] × [1 + .06]] × (.80) = $2.42

As shown in the table, a charge computation routine is performed using a variety of variables, including provider data and recipient data. Using the data, which may include allocation data, markup data, revenue data, and so on, the charge computation routine determines that a recipient charge to be applied to the recipient of the service is $2.42. This charge may then be used when generating transfer-pricing documentation for the service.

The example above was performed for one service provider in the U.S. and one service recipient in Europe. Additional results could include computation of a charge from a global headquarters department which cascades to the Europe headquarters then to the European recipient. Another calculation would be the inclusion of a divisional headquarters between the corporate and geographic headquarters, or between the regional headquarters and the recipient, with cascading allocations. Similar computations would be performed where there were more than one regional and divisional headquarters, and more than one entity in each region or division.

In addition to charge calculations, the system may also utilize the cost allocation module 300 when performing cost sharing calculations using a variety of drivers as prescribed by the transfer pricing rules for these transactions. In addition, the system may also utilize the cost allocation module 300 when performing royalty calculations for a variety of assets within an organization, such as intellectual property assets and other intangible assets. Table 4 provides example guidelines followed by the cost allocation module 300 when performing dynamic royalty calculations for such assets:

TABLE 4

| Pre | Step | | | | | |
|---|---|---|---|---|---|---|
| Royalty | (Change in | | | Licensee Post | | |
| Pre-Tax | boundary | | Royalty | Royalty Pre-Tax | Profit Split- | Profit Split- |
| Profit % | condition) | Formula | Percentage | Profit % | Licensor | Licensee |
| 0% | 1 | Profit-2% | 0.0% | 0.0% | 0.0% | 0.0% |
| 1% | | Profit-2% | 0.0% | 1.0% | 0.0% | 100.0% |
| 2% | | Profit-2% | 0.0% | 2.0% | 0.0% | 100.0% |
| 3% | | Profit-2% | 1.0% | 2.0% | 0.0% | 100.0% |
| 4% | | Profit-2% | 2.0% | 2.0% | 0.0% | 100.0% |
| 5% | | Profit-2% | 3.0% | 2.0% | 0.0% | 100.0% |
| 6% | 2 | Profit-3.0% | 3.0% | 3.0% | 50.0% | 50.0% |
| 7% | | Profit-3.5% | 3.5% | 3.5% | 50.0% | 50.0% |
| 8% | | Profit-4.5% | 3.5% | 4.5% | 43.8% | 56.3% |
| 9% | | Profit-5.5% | 3.5% | 5.5% | 38.9% | 61.1% |
| 10% | | Profit-6.3% | 3.7% | 6.3% | 37.0% | 63.0% |
| 11% | | Profit-7.0% | 4.0% | 7.0% | 36.4% | 63.6% |
| 12% | | Profit-7.6% | 4.4% | 7.6% | 36.7% | 63.3% |
| 13% | | Profit-8.1% | 4.9% | 8.1% | 37.7% | 62.3% |
| 14% | | Profit-8.5% | 5.5% | 8.5% | 39.3% | 60.7% |
| 15% | 3 | Fixed | 6.0% | 9.0% | 40.0% | 60.0% |
| 16% | | Fixed | 6.0% | 10.0% | 37.5% | 62.5% |
| 17% | | Fixed | 6.0% | 11.0% | 35.3% | 64.7% |
| 18% | | Fixed | 6.0% | 12.0% | 33.3% | 66.7% |
| 19% | | Fixed | 6.0% | 13.0% | 31.6% | 68.4% |
| 20% | | Fixed | 6.0% | 14.0% | 30.0% | 70.0% |
| 21% | 4 | Fixed | 6.5% | 14.5% | 31.0% | 69.0% |
| 22% | | Fixed | 6.5% | 15.5% | 29.5% | 70.5% |
| 23% | | Fixed | 6.5% | 16.5% | 28.3% | 71.7% |
| 24% | | Fixed | 6.5% | 17.5% | 27.1% | 72.9% |
| 25% | | Fixed | 6.5% | 18.5% | 26.0% | 74.0% |

Following the example, given a pre-royalty, pre-tax profit of 3% for a given asset, the system calculates, using a formula specific to the profit percentage, a royalty percentage to be 1%, with a 100% profit split being applied to the licensee of the asset. However, given a pre-royalty, pre-tax profit of 21% for another asset, the system calculates, using a formula specific to the profit percentage, a royalty percentage of 6.5%, with a 69% profit split being applied to the licensee. Thus, the system may facilitate a flexible and dynamic calculation of royalties depending on the ever-changing value of assets within the organization, among other benefits.

In addition to dynamic royalty calculations, the system may also utilize the cost allocation module 300 when performing profit split calculations for a variety of assets within an organization, such as intellectual property assets and other intangible assets. Table 5 provides example guidelines followed by the cost allocation module 300 when performing profit split calculations for such assets:

TABLE 5

| | | | | | Step |
|---|---|---|---|---|---|
| | | | | Licensee | (Change |
| Licensee Pre | Profit | Profit | Royalty | Post | in |
| Royalty Pre- | Split - | Split - | Percent- | Royalty Pre- | boundary |
| Tax Profit % | Licensor | Licensee | age | Tax Profit % | condition) |
| 0% | 0.0% | 0.0% | 0% | 0.0% | 1 |
| 1% | 50.0% | 50.0% | 1% | 0.5% | |
| 2% | 50.0% | 50.0% | 1% | 1.0% | |
| 3% | 50.0% | 50.0% | 2% | 1.5% | |
| 4% | 50.0% | 50.0% | 2% | 2.0% | |
| 5% | 50.0% | 50.0% | 3% | 2.5% | |
| 6% | 50.0% | 50.0% | 3% | 3.0% | |
| 7% | 50.0% | 50.0% | 4% | 3.5% | |
| 8% | 50.0% | 50.0% | 4% | 4.0% | |
| 9% | 50.0% | 50.0% | 5% | 4.5% | |
| 10% | 50.0% | 50.0% | 5% | 5.0% | |
| 11% | 50.0% | 50.0% | 6% | 5.5% | |
| 12% | 50.0% | 50.0% | 6% | 6.0% | |
| 13% | 50.0% | 50.0% | 7% | 6.5% | |
| 14% | 50.0% | 50.0% | 7% | 7.0% | |
| 15% | 25.0% | 75.0% | 4% | 11.3% | 2 |
| 16% | 25.0% | 75.0% | 4% | 12.0% | |
| 17% | 25.0% | 75.0% | 4% | 12.8% | |
| 18% | 25.0% | 75.0% | 5% | 13.5% | |
| 19% | 25.0% | 75.0% | 5% | 14.3% | |
| 20% | 25.0% | 75.0% | 5% | 15.0% | |
| 21% | 25.0% | 75.0% | 5% | 15.8% | |
| 22% | 25.0% | 75.0% | 6% | 16.5% | |
| 23% | 25.0% | 75.0% | 6% | 17.3% | |
| 24% | 25.0% | 75.0% | 6% | 18.0% | |
| 25% | 25.0% | 75.0% | 6% | 18.8% | |

For example, using the table, a licensee obtaining a pre-royalty pre-tax profit of 14% will cause a 50-50 profit split between licensee and licensor, with a royalty percentage of 7% and a post-royalty pre-tax profit of 7%, whereas a licensee obtaining a pre-royalty pre-tax profit of 24% will cause a 75-25 profit split between licensee and licensor, with a royalty percentage of 6% and a post-royalty pre-tax profit of 18%. Thus, the system may facilitate the flexible and dynamic profit-split calculations of royalties depending on the ever-changing value of assets within the organization, among other benefits.

As a final example, the system may also utilize the cost allocation module 300 when performing residual royalties calculations for a variety of assets within an organization, such as intellectual property assets and other intangible assets. Table 6 provides example guidelines followed by the cost allocation module 300 when performing residual royalty calculations for such assets:

TABLE 6

| | | | | | | Step |
|---|---|---|---|---|---|---|
| Licensee Pre | | | Licensee Post | | | (Change in |
| Royalty Pre- | Target Profit | Royalty | Royalty Pre- | Profit Split— | Profit Split— | boundary |
| Tax Profit % | Limit | Percentage | Tax Profit % | Licensor | Licensee | condition) |
| 0% | 5% | 0% | 0.0% | 0.0% | 0.0% | 1 |
| 1% | 5% | 0% | 1.0% | 0.0% | 100.0% | |
| 2% | 5% | 0% | 2.0% | 0.0% | 100.0% | |
| 3% | 5% | 0% | 3.0% | 0.0% | 100.0% | |
| 4% | 5% | 0% | 4.0% | 0.0% | 100.0% | |
| 5% | 5% | 0% | 5.0% | 0.0% | 100.0% | |
| 6% | 5% | 1% | 5.0% | 16.7% | 83.3% | 2 |
| 7% | 5% | 2% | 5.0% | 28.6% | 71.4% | |
| 8% | 5% | 3% | 5.0% | 37.5% | 62.5% | |
| 9% | 5% | 4% | 5.0% | 44.4% | 55.6% | |
| 10% | 5% | 5% | 5.0% | 50.0% | 50.0% | |
| 11% | 5% | 6% | 5.0% | 54.5% | 45.5% | |
| 12% | 5% | 7% | 5.0% | 58.3% | 41.7% | |
| 13% | 5% | 8% | 5.0% | 61.5% | 38.5% | |
| 14% | 5% | 9% | 5.0% | 64.3% | 35.7% | |
| 15% | 5% | 10% | 5.0% | 66.7% | 33.3% | |
| 16% | 5% | 11% | 5.0% | 68.8% | 31.3% | |
| 17% | 5% | 12% | 5.0% | 70.6% | 29.4% | |
| 18% | 5% | 13% | 5.0% | 72.2% | 27.8% | |
| 19% | 5% | 14% | 5.0% | 73.7% | 26.3% | |
| 20% | 5% | 15% | 5.0% | 75.0% | 25.0% | |
| 21% | 5% | 16% | 5.0% | 76.2% | 23.8% | |
| 22% | 5% | 17% | 5.0% | 77.3% | 22.7% | |
| 23% | 5% | 18% | 5.0% | 78.3% | 21.7% | |
| 24% | 5% | 19% | 5.0% | 79.2% | 20.8% | |
| 25% | 5% | 20% | 5.0% | 80.0% | 20.0% | |

For example, using the table, a licensee obtaining a pre-royalty pre-tax profit of 5% will be allocated a post-royalty pre-tax profit of 5%, whereas a licensee obtaining a pre-royalty pre-tax profit of 15% will also be allocated a post-royalty pre-tax profit of 5%. Thus, the system may facilitate the flexible and dynamic calculations of residual royalties depending on the ever-changing value of assets within the organization, among other benefits.

### CONCLUSION

While certain aspects of the system are presented below in certain claim forms, the inventor contemplates the various aspects of the system in any number of claim forms. Accordingly, the inventor reserves the right to add additional claims after filing the application to pursue such additional claim forms for other aspects of the system.

1. A system for generating services and intangibles transfer price documentation for an enterprise, the system comprising:
an input component, wherein the input component is configured to automatically receive input from an enterprise resource planning system associated with a first entity within the enterprise;
a determination component, wherein the determination component is configured to determine transfer prices based on input received by the input component and from the enterprise resource planning system associated with the first entity; and
an output component, wherein the output component is configured to automatically generate reports based on the determined transfer prices for service providers and service recipients within the enterprise.

2. The system of claim 1, wherein the determination component is configured to determine the transfer prices by performing multiple step allocations on the input received from the enterprise resource planning system associated with the first entity.

3. The system of claim 1, wherein the input component is configured to automatically receive recipient and provider identity map information, department description information, department cost information, department allocation information, and service type markup information from the enterprise resource planning system associated with the first entity.

4. The system of claim 1, wherein the output component is configured to automatically generate a report that provides information about allocations for one or more departments within the enterprise.

5. The system of claim 1, wherein the output component is configured to automatically generate a report that provides information about a tax impact of allocations within the enterprise.

6. The system of claim 1, wherein the output component is configured to automatically generate a report that provides information about reconciliations within the enterprise.

7. The system of claim 1, wherein the output component is configured to automatically generate a report that provides supporting documentation for the determined transfer prices.

8-32. (canceled)
